(19) United States
(12) Patent Application Publication
(10) Pub. No.: US 2019/0096254 A1
(43) Pub. Date: Mar. 28, 2019

(54) METHOD AND SYSTEM FOR CAPTURING OPERATION VARIABLES FOR VEHICLES

(71) Applicant: Jordan Christopher Havercamp, Orlando, FL (US)

(72) Inventor: Jordan Christopher Havercamp, Orlando, FL (US)

(21) Appl. No.: 16/050,879

(22) Filed: Jul. 31, 2018

Related U.S. Application Data
(60) Provisional application No. 62/539,477, filed on Jul. 31, 2017.

(51) Int. Cl. G08G 1/14; G06K 9/00; G06K 9/32; G06K 9/62; G06N 20/00

(52) U.S. Cl. CPC G08G 1/144; G06K 9/00818; G06N 20/00; G06K 9/3241; G06K 9/6262; G06K 9/3258

(57) ABSTRACT

Disclosed is a method of facilitating and capturing legal operation of vehicles is provided. The method may include receiving, using a communication device, at least one parking/stopping/standing update from at least one mobile device. Further, the parking/stopping/standing update may be associated with a location. Furthermore, the method may include analyzing, using a processing device, at least one parking/stopping/standing update. Additionally, the method may include generating, using the processing device, operation data associated with the location based on the request. Further, the method will provide a process loop to improve identification and/or capturing of relevant variables to be used while facilitating legal operation of vehicles.

### FIELD OF DISCLOSURE

The present disclosure generally relates to digital data processing. More specifically, the disclosure relates to methods and systems for facilitating parking/stopping/standing of vehicles via capturing of relevant variables during data collection.

### BACKGROUND

Parking tickets are a major problem and expense for private and commercial vehicle operators around the world. Parking rules are not clear, opaque, ambiguous, incoherent and confusing, leaving operators in the dark as to compliance with the applicable parking rules. As a result, a huge amount of money is spent by individuals and companies on parking violations. For example, according to some estimates, vehicles get an average of four tickets a year.

Further, a lot of time and money is lost in trying to find the best parking option. More importantly, fuel is consumed by simply trying to locate a parking lot. This excess traffic leads to excessive gasoline consumption, loss of time, traffic congestion and pollution from emissions. For example, according to a study, vehicles circling city blocks in search for a parking spot increase traffic in big cities by as much as thirty percent. In other words, this stressful process feeds on itself by worsening traffic conditions when looking for a place to park.

Conventional navigation programs offer a guidance service to guide the driver to a destination but do not provide information on available parking near the destination or a service to guide the driver to an area that legally allows for drop off and pickup of passengers. Therefore, drivers must look for parking lots or designated zones near their destination to park or stop their vehicles. In addition, even if drivers find adequate parking, they may have to look for a different car park if there are no empty parking spaces in the parking lot or on the street.

Accordingly, there is a need for methods and systems for facilitating parking of vehicles, while overcoming one or more of the aforementioned drawbacks.

### BRIEF OVERVIEW

This brief overview is provided to introduce a selection of processes in a simplified form that are further described below in the Detailed Description. This brief overview is not intended to identify key features or essential features of the claimed subject matter. Nor is this brief overview intended to be used to limit the claimed subject matter's scope.

In accordance with some embodiments, a first method of facilitating parking of vehicles is provided. The first method may include receiving, using a communication device, a location of a mobile device associated with a vehicle. Further, the first method may include retrieving parking data associated with the location from a storage device. Furthermore, the first method may include transmitting, using the communication device, the parking data to the mobile device. Additionally, the mobile device may be configured to present the parking data to a user of the mobile device.

Also disclosed is a second method of facilitating parking of vehicles in accordance with another embodiment. The second method may include receiving, using a communication device, at least one parking update from at least one mobile device. Further, the parking update may be associated with a location. Furthermore, the second method may include analyzing, using a processing device, the at least one parking update. Additionally, the second method may include generating, using the processing device, parking data associated with the location based on the parking update. Further, the second method may include storing each of the parking data and the location in a storage device.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates a block diagram of an operating environment consistent with the present disclosure.

FIG. 2 illustrates a flowchart of a first method 200 of facilitating parking of vehicles, in accordance with some embodiments.

FIG. 3 illustrates a flowchart of a second method 300 of facilitating parking of vehicles based on parking updates provided by users, in accordance with some embodiments.

FIG. 4 illustrates screenshot 3000 of the add-parking information page showing capturing of an image of the parking regulations for providing parking time limit associated with a parking location, in accordance with some embodiments.

FIG. 5-7 illustrates screenshots 3100-3300 of the parking guidance page showing parking data for a location at different times of a day and pricing information, in 1 accordance with some embodiments.

FIG. 8 illustrates a block diagram of a system 3700 for facilitating parking of vehicles, in accordance with some embodiment.

FIG. 9 illustrates machine vision recognition, division, and subdivision for parking variables 3400, in accordance with some embodiment.

FIG. 10 illustrates a flow chart 3500 of categories and sub-categories and/or types and sub-types of key variables, in accordance with some embodiment.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of parking of vehicles, embodiments of the present disclosure are not limited to use only in this context. For example, the methods and systems disclosed herein may be applied to collecting and distributing relevant information about roads (e.g. pedestrian crossings, cycle tracks, skateboarding lanes, taxi and rideshare pick-up and drop off locations, etc.) to other road users, such as, for example, pedestrians, cyclists, commercial drivers and so on. Moreover, methods and systems can be employed in assisting autonomous vehicles, or in-vehicle, parking information, drop off and pick up locations. Further still, methods and systems disclosed herein may be employed to:
Assist people finding legal parking
Assist people finding available parking
Assist people reading a parking sign
Permit parking mapping
Temporary Parking Sign reporting
Valet parking meter regulation
Competitive pricing flexibility
City Planning design guidance
City Planning recommendation
City Planning Parking Distribution
City data collection
Urban infrastructure mapping
Micro street data collection
Traffic control traffic and guidance monitoring
Emergency response vehicle relocation
Parking and Mobility Legality Assistance
Rideshare pickup and drop-off check
Rideshare pickup and drop-off recommendation
Rental Car return guidance
Autonomous vehicle navigation
Destination Parking recommendation
Alternative mode of transportation recommendation
Variable pricing recommendation

I. Platform Overview

Consistent with embodiments of the present disclosure, an online platform (also referred to herein as “platform” or “vehicle parking platform” or “parking platform”) for facilitating operation of vehicles may be provided. This overview is provided to introduce a selection of processes in a simplified form that are further described below. This overview is not intended to identify key features or essential features of the claimed subject matter. Nor is this overview intended to be used to limit the claimed subject matter's scope. The online platform may be used by individuals (e.g. drivers, rideshare hailers, etc.) or companies (e.g. traffic management agencies, parking space providers, urban planners, parking enforcement, automobile manufacturers, etc.) to facilitate parking of vehicles and/or city planning.

According to some embodiments, the present disclosure provides a parking app (also referred to as “ParkParkGoose” herein) executable on a mobile device (e.g. smartphone, vehicle navigation unit etc.) that enables users to tap, park and go with ease, knowing that they have safely parked their car each and every time and/or acted in accordance with local laws and regulations.

ParkParkGoose turns complex parking rules into simple yes or no answers, allowing users to park like a native wherever they are. The parking information collected and generated by the parking platform is kept current and up-to-date by city regulations as well as users. If users see a change or a temporary no parking sign, they are enabled to input such information into the parking app so other users can avoid being fined.

By using GPS location, time and day, and user variables like permits and placards, compared to regulations in the area, the parking app/technology may provide parking/stopping/standing legality and payment guidance in real-time in order to check legality of manual parking and/or automated parking and/or commercial stopping and standing. Further, the parking information may be critical for autonomous vehicle navigation as well as rideshare companies operating legally by city and state rules and regulations. The parking information may be provided through the parking app, an API, or built in car technology.

Further, the parking app may include a “Plan Ahead Feature” that allows for the manipulation of time and day to show the parking environment in advance. For instance, within the parking app, a user may be enabled to change the time and day as variable parameters. Accordingly, the parking app may change an output answer based on the new parameters and reflects this in each of the parking sign answer, parking preview, and line color representation.

Further, according to some embodiments, the parking platform and/or the parking app may enable users to add parking data via their mobile phone and camera and perform immediate machine calculation and interpretation of the parking data. In other words, by performing the interpretation of the parking data received from users based on parking laws and regulations, the parking platform may achieve a much greater success rate of accuracy as compared to that performed by humans. Even when information is missing from a sign, machine learning performed by the parking platform can fill in the missing variables that would be much more difficult and time consuming for a person.

Accordingly, the user may be presented with options to add the parking data. Further, the user can select what type of parking data to add. For example, the user can add a parking sign or meter with a first button, a curb or street with no posted parking sign with a second button, parking garage or parking lot with a third button, valet parking with a fourth button, or cancel out of the process with a fifth button.

Accordingly, in some embodiments, the present disclosure may provide a method for enabling the user to provide parking data. The method may include manually obtaining a Photo, a Video, a Scan or an Audible corresponding to Signs, Meters, Curbs, Valets, Lots, & Garages etc. Initially, the user may select the option of “add parking info”. Next, the user may select what type of parking info (Signs, Meters, Curbs, Valets, Lots, & Garages) the user wishes to add. Thereafter, the parking app may automatically identify the location of the user based on GPS. Further, in some embodiments, the location may be presented to the user in order to enable the user to correct the location if there is any discrepancy. Accordingly, the location of the user may be confirmed. Further, the parking app may identify the street, nearby signs, nearby intersections, and the side of street on which the user is located. Thereafter, the parking app may recommend a sign to be added based on predictive probability. However, if the user does not choose recommended, the user may manually add the sign via scan, video, photo or speech. In an instance, the user may manually add relevant information on the sign such as, but not limited to, regulation type, pricing, days, times, permits, exceptions, arrows, etc. In another instance, the user may perform image capturing in order to add relevant information. Further, the image capturing may include several processes to make the image more desirable or readable including filter and color altering. For example, the user may perform a Scan by use of a camera to scan over the sign(s) capturing all relevant information. Alternatively, and/or additionally, the user may take a photo of the sign(s) capturing all relevant information. Alternatively, and/or additionally, the user may record a video of the sign(s) capturing all relevant information.

Thereafter, the parking app and/or the parking platform may translate the recorded parking information into logic (programming logic). To this end, the method may employ Optical Character Recognition (OCR) that recognizes text in the image to autofill sign information. Further, the method may employ Machine Vision (MV) that gives pass/fail results if data is accurate or usable. This may be used in sign/regulation verification process or maintenance requests. Further, the method may employ computer vision that automates human visual system for immediate image recognition. Accordingly, the image of the sign gets cross referenced with a parking sign database or training data to immediately recognize what type of parking sign/regulation is being represented.

Further, the method may employ Artificial Intelligence (AI). Accordingly, computer generated understanding of parking data, sign recognition, and image classification (as fast or faster/better than humans) may be performed. Additionally, the method may employ Machine Learning by processing images through a hard-coded database of parking images that are labeled with relevant variables. This enables automatic categorizing of parking information so the parking sign database grows, learns, and becomes more accurate with time and increased data. Furthermore, the method may employ Deep Learning. Accordingly, the parking platform may take basic line and shape recognition to build a hierarchical identification of complex concepts like parking signs in a neural network. Then, the parking platform concludes which features are responsible for finding an answer to a parking question and those variables are converted into parking logic.

Subsequently, the parking app compares logic to real life circumstances and variables such as time, day, week, city, county, state, country, and user permits/placards, etc. to calculate a custom answer to the parking question. Further, the parking app may also identify and explain what rule is currently in effect for a comprehensive understanding of the rules and regulations. This includes pricing information and estimated cost to park depending on duration requested. For example, a garage may offer free parking for 90 minutes and then it costs $2/15 minutes thereafter. Accordingly, the parking app may inform the user expecting to park for 2 hours that it will cost ˜$4 to park for 2 hours.

Additionally, the parking app may also create a digital parking sign displaying all relevant parking information in a simplified and more comprehensive fashion. Further, Lines/Signs may be drawn/represented on map showing the zone in which those regulations are in affect and are color coded to create a visual understanding of parking legality that is customized to the user specific circumstance and desired action.

Further, in order to capture the image including parking information, the method may include the following steps (varying order may occur):
1. The user clicks add information.
2. The user selects the type of structure (sign, meter, garage, lot, curb, valet, etc.)
3. The user chooses image capture (photo, scan, video). In some embodiments, car sensors/cameras (e.g. in autonomous vehicles) may capture this information without user assistance.
4. The user takes a photo, scans, or records the sign(s)
   4.1. Photo: align photo within box outlined in camera filter. Take photo. Confirm photo. Submit photo. Receive answer.
   4.2. Scan: Using the camera on the phone, scan over the sign(s) from top to bottom. Each sign/regulation is recorded.
   4.3. Video: Record the sign(s) and submit. Accordingly, the parking app may identify the best still image from the video which will be used to analyze and identify regulation variables. The photo/video is analyzed with AI which identifies relevant information within the still/image/video. That information is then digitally cropped. Cropped selection is then reoriented and filtered for a better angle/lighting/clarity/etc which is used for analysis.
5. The image is then analyzed in order to retrieve the relevant parking information. Words/letters/numbers/shapes/design/pictures/color/etc are all taken into account on all images, and assigned to corresponding categories and subcategories and/or types and sub-types.

II. Platform Configuration

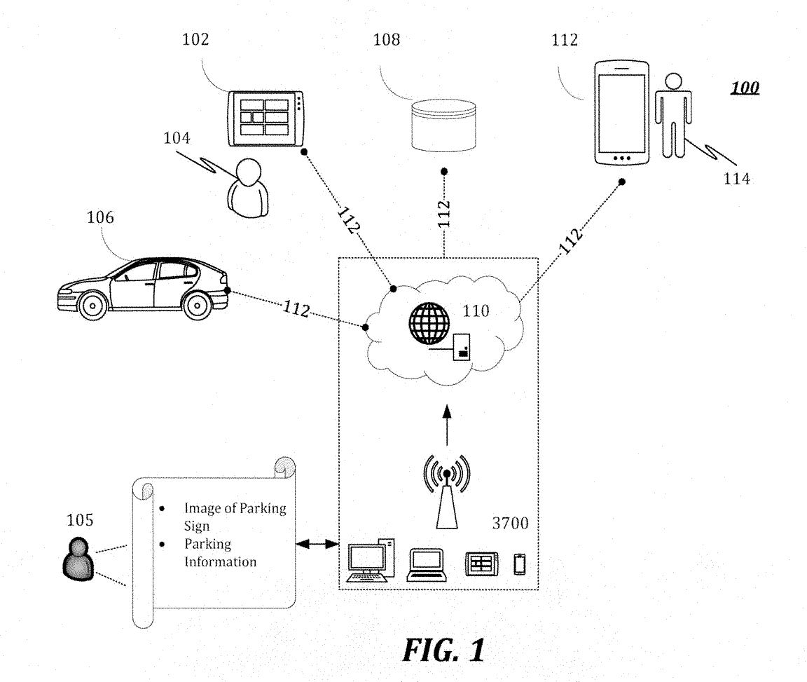

FIG. 1 is an illustration of a platform consistent with various embodiments of the present disclosure. By way of non-limiting example, the online platform 100 for facilitating parking of vehicles may be hosted on a centralized server 110, such as, for example, a cloud computing service. The centralized server may communicate with other network entities, such as, for example, a mobile device 102 (such as a smartphone, a laptop, a tablet computer, a vehicle navigation unit etc.) operated by a user 104 (such as a driver of a vehicle), an electronic device 112 operated by a user 114 (such as another user such as a pedestrian), a vehicle automation unit 106 (or vehicle navigation unit) and a storage device 108 comprising parking data over a communication network 112, such as, but not limited to, the Internet. Further, users of the platform may include one or more relevant parties such as, drivers, pedestrians, managers of facilities such as buildings, administrators of vehicle fleet management and so on. Accordingly, electronic devices (e.g. smartphones, tablet computers, laptop computers, desktop computers, wearable computers etc.) operated by the one or more relevant parties may be in communication with the platform 100.

A user 105, such as a driver, may access platform 100 through a software application. The software application may be embodied as, for example, but not be limited to, a website, a web application, a desktop application, and a mobile application compatible with a computing device 3700. One possible embodiment of the software application may be provided by ParkParkGoose™ products and services. Accordingly, in an instance, the user 105 may be provide an image of a parking sign and optionally additional parking information to the parking platform 100. Accordingly, the parking platform 100 may be configured to analyzing the image and optionally the additional parking information in order to generate parking data. Subsequently, the parking platform 100 may provision the parking data to users, such as, for example, drivers.

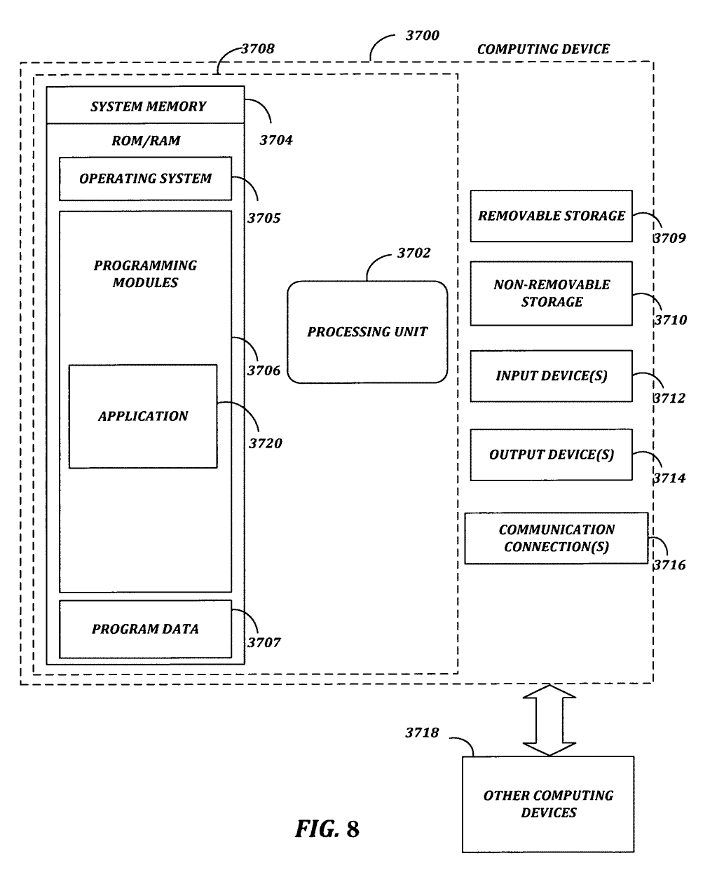

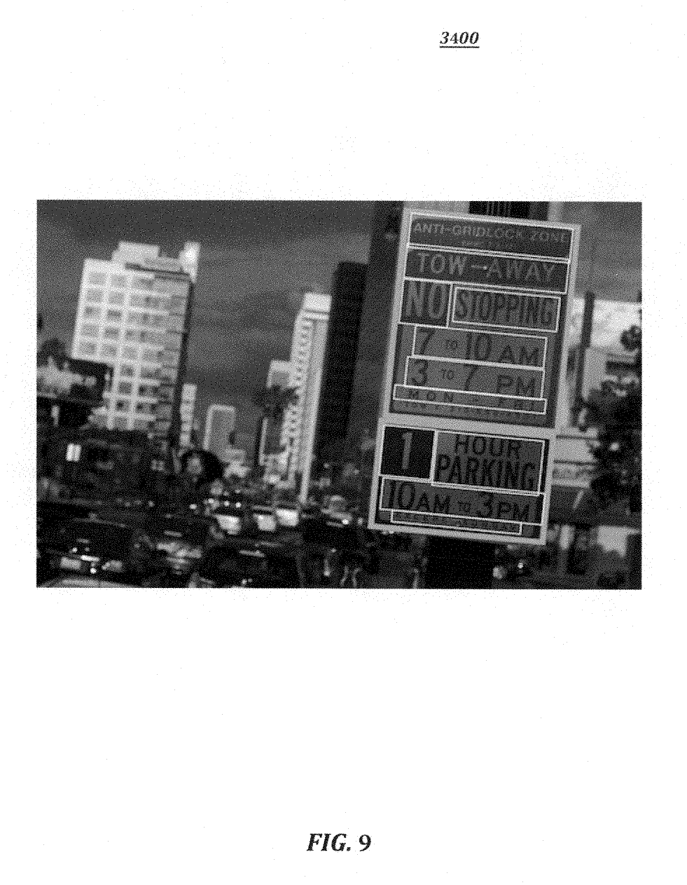

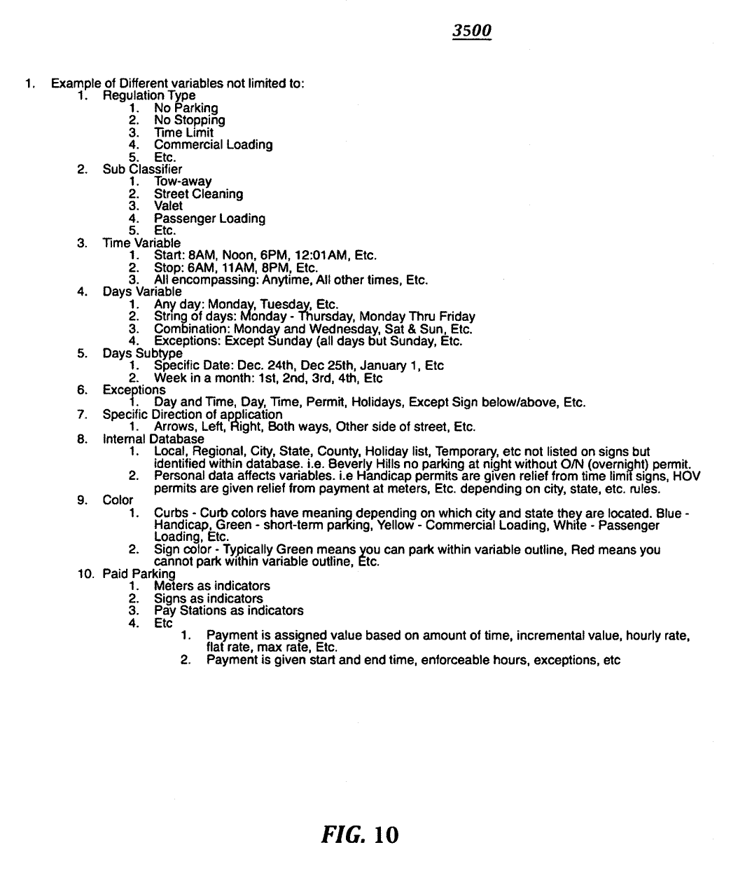

As will be detailed with reference to FIG. 8 below, the computing device through which the online platform may be accessed may comprise, but not be limited to, for example, a desktop computer, laptop, a tablet, or mobile telecommunications device. As will be detailed with reference to FIG. 8 below, the computing device through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein.

III. Platform Operation

Although methods 200 and 300 have been described to be performed by platform 100, it should be understood that computing device 3700 may be used to perform the various stages of methods 200 and 300. Furthermore, in some embodiments, different operations may be performed by different networked elements in operative communication with computing device 3700. For example, server 110 may be employed in the performance of some or all of the stages in methods 200 and 300. Moreover, server 110 may be configured much like computing device 3700.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of methods 200 and 300 will be described in greater detail below.

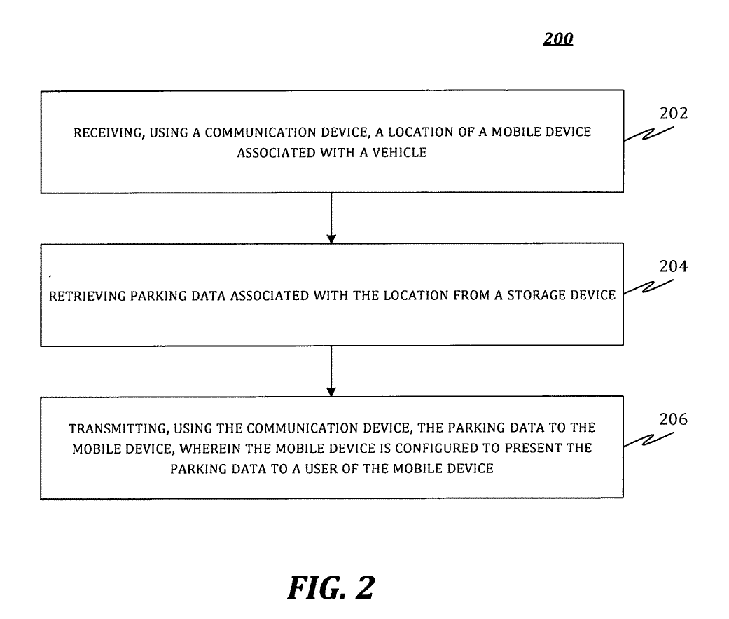

FIG. 2 illustrates a flowchart of a first method 200 of facilitating parking of vehicles is provided. The first method 200 may include a stage 202 of receiving, using a communication device, a location of a mobile device associated with a vehicle. In some embodiments, the mobile device may include one or more of a smartphone and a vehicle navigation unit.

Further, the first method 200 may include a stage 204 of retrieving parking data associated with the location from a storage device. In some embodiments, the parking data may include one or more of at least one parking location, at least one availability associated with the at least one parking location, at least one time associated with the at least one availability, at least one parking meter location associated with the at least one parking location, at least one parking regulation associated with the at least one parking regulation, at least one type of parking associated with the at least one parking location and at least one price associated with the at least one parking location.

Further, the first method 200 may include a stage 206 of transmitting, using the communication device, the parking data to the mobile device. Furthermore, the mobile device may be configured to present the parking data to a user of the mobile device. In some embodiments, presenting the parking data may include displaying the parking data overlaid on a map. In some embodiments, the displaying may be performed based on a color code. Further, a parking datum may be displayed in a color associated with the parking datum according to the color code. In some embodiments, the first method 200 may further include receiving, using the communication device, a filtering criteria. Further, presenting the parking data may be based on the filtering criteria.

In some embodiments, the first method 200 may further include receiving, using the communication device, at least one contextual variable. Further, retrieving the parking data may be further based on the contextual variable. In some embodiments, the contextual variable may include at least one a time of day, a day of week, a lane of a road associated with the location, a level of traffic congestion in a vicinity of the location, a number of vehicles currently seeking parking in the vicinity of the location, at least one characteristic of a user associated with the vehicle, at least one characteristic of the vehicle, at least one permit associated with the vehicle and at least one parking violation associated with one or more of the vehicle and the user.

In some embodiments, the first method 200 may further include stages of: a) receiving, using the communication device, sensor data associated with at least one sensor comprised in the mobile device; b) analyzing, using the processing device, the sensor data; c) determining, using the processing device, a parking state associated with the vehicle based on the analyzing; and d) storing the parking state in the storage device.

In some embodiments, the first method 200 may further include transmitting, using the communication device, at least one notification to the mobile device upon expiry of a time-period based on the parking state. Further, the parking state corresponds to the vehicle being parked at the location.

In some embodiments, the parking data may include at least one parking location and at least one availability associated with the at least one parking location. Further, the at least one availability may be based on the parking state.

In some embodiments, the first method 200 may further include the stages of: e) receiving, using the communication device, a parking update from the mobile device; f) updating, using the processing device, the parking data based on the parking update; and g) storing the updated parking data in the storage device.

In some embodiments, the first method 200 may further include receiving, using the communication device, a radius corresponding to a geofence from the mobile device. Further, the geofence surrounds the location. Further, the parking data may be presented on the mobile device when a current location of the mobile device falls within the geofence.

In some embodiments, the parking data may include at least one parking location and at least one availability associated with the at least one parking location. Further, the at least one availability may be based on detecting the user entering the geofence.

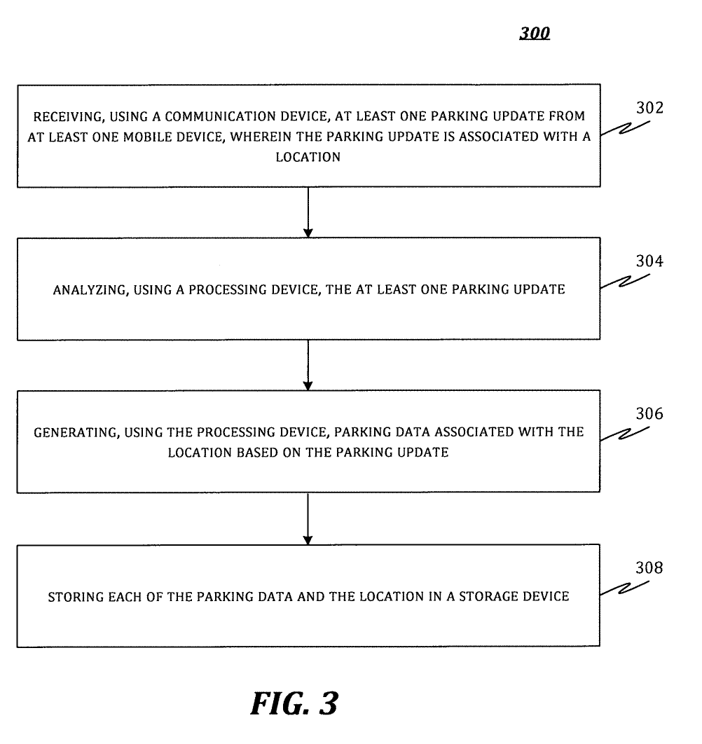

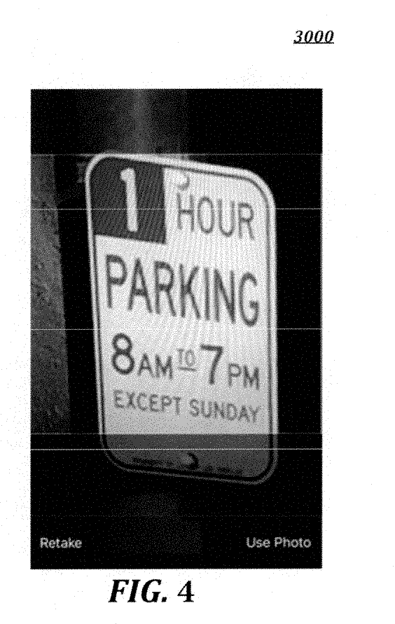

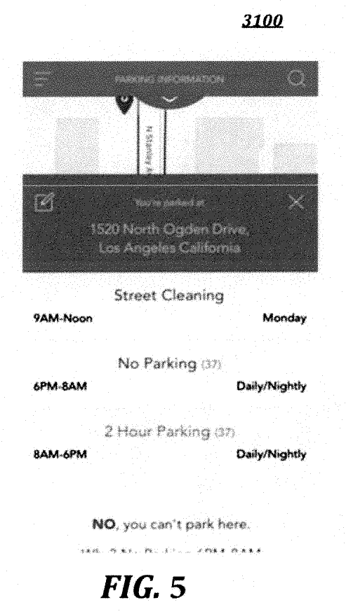

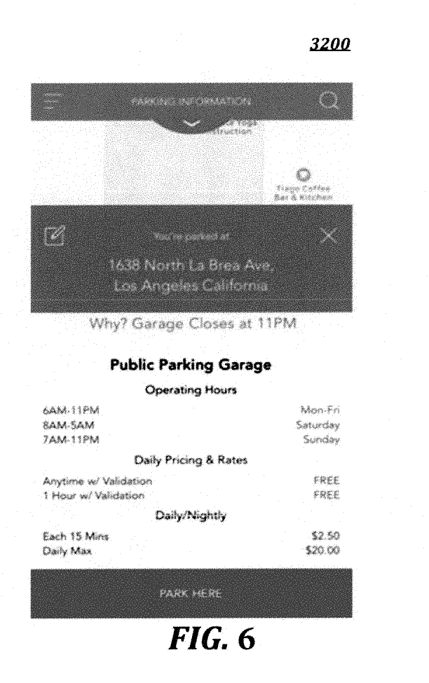

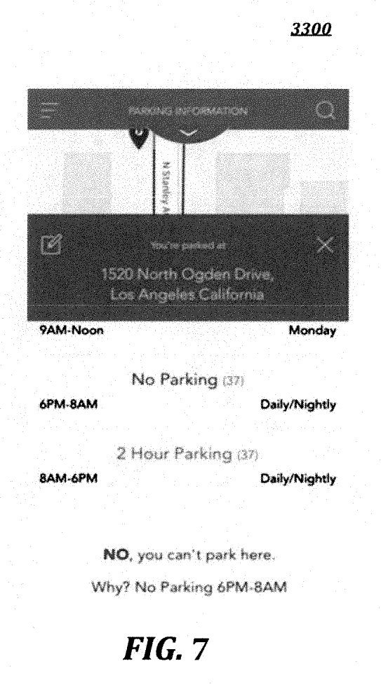

FIG. 3 illustrates a flow chart of a second method 300 of facilitating parking of vehicles in accordance with another embodiment. The second method 300 may include receiving, using a communication device, at least one parking update from at least one mobile device. Further, the parking update may be associated with a location. Furthermore, the second method 300 may include analyzing, using a processing device, the at least one parking update. Additionally, the second method 300 may include generating, using the processing device, parking data associated with the location based on the parking update. Further, the second method 300 may include storing each of the parking data and the location in a storage device.

In some embodiments, the parking update may include a plurality of scans 3000 including a plurality of portions of a parking sign, an image including the parking sign, a video including the parking sign and an audio describing the parking sign.

In some embodiments, the parking update may include an image of the parking sign. Further, the analyzing may subdivide by area of key identifiers and/or variable word(s) and/or image(s) 3400. Further, the analyzing may include performing one or more of a supervised classification and unsupervised classification of the image based on machine learning 3500.

In some embodiments, the second method 300 may further include stages of: a) receiving, using the communication device, the location from the mobile device; b) retrieving a plurality of predetermined parking data associated with the location from a storage device; and c) transmitting, the plurality of predetermined parking data to the mobile device. Additionally, the plurality of predetermined parking data may be presented on the mobile device. Further, the mobile device may be configured to receive at least one selection of the plurality of predetermined parking data. Furthermore, the at least one selection corresponds to the at least one parking update.

In some embodiments, the second method 300 may further include generating, using the processing device, the plurality of predetermined parking data based on predictive probabilities. In some embodiments, the parking update may include one or more of at least one parking location, at least one availability associated with at least one parking location, at least one time associated with at least one availability, at least one parking meter location associated with at least one parking location, at least one parking regulation associated with at least one parking regulation, at least one type of parking associated with at least one parking location and at least one price associated with at least one parking location.

IV. Platform Architecture

The platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the platform 100 may be hosted on a centralized server, such as, for example, a cloud computing service. Although methods 200 and 300 have been described to be performed by a computing device 3700, it should be understood that, in some embodiments, different operations may be performed by different networked elements in operative communication with computing device 3700.

Embodiments of the present disclosure may comprise a system having a memory storage and a processing unit. The processing unit coupled to the memory storage, wherein the processing unit is configured to perform the stages of methods 200 and 300.

FIG. 8 is a block diagram of a system including computing device 3700. Consistent with an embodiment of the disclosure, the aforementioned memory storage and processing unit may be implemented in a computing device, such as computing device 3700 of FIG. 8. Any suitable combination of hardware, software, or firmware may be used to implement the memory storage and processing unit. For example, the memory storage and processing unit may be implemented with computing device 3700 or any of other computing devices 3718, in combination with computing device 3700. The aforementioned system, device, and processors are examples and other systems, devices, and processors may comprise the aforementioned memory storage and processing unit, consistent with embodiments of the disclosure.

With reference to FIG. 8, a system consistent with an embodiment of the disclosure may include a computing device or cloud service, such as computing device 3700. In a basic configuration, computing device 3700 may include at least one processing unit 3702 and a system memory 3704. Depending on the configuration and type of computing device, system memory 3704 may comprise, but is not limited to, volatile (e.g. random access memory (RAM)), non-volatile (e.g. read-only memory (ROM)), flash memory, or any combination. System memory 3704 may include operating system 3705, one or more programming modules 3706, and may include a program data 3707. Operating system 3705, for example, may be suitable for controlling computing device 3700's operation. In one embodiment, programming modules 3706 may include image encoding module, machine learning module and image classifying module. Furthermore, embodiments of the disclosure may be practiced in conjunction with a graphics library, other operating systems, or any other application program and is not limited to any particular application or system. This basic configuration is illustrated in FIG. 8 by those components within a dashed line 3708.

Computing device 3700 may have additional features or functionality. For example, computing device 3700 may also include additional data storage devices (removable and/or non-removable) such as, for example, magnetic disks, optical disks, or tape. Such additional storage is illustrated in FIG. 8 by a removable storage 3709 and a non-removable storage 3710. Computer storage media may include volatile and nonvolatile, removable and non-removable media implemented in any method or technology for storage of information, such as computer readable instructions, data structures, program modules, or other data. System memory 3704, removable storage 3709, and non-removable storage 3710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 3700. Any such computer storage media may be part of device 3700. Computing device 3700 may also have input device(s) 3712 such as a keyboard, a mouse, a pen, a sound input device, a touch input device, etc. Output device(s) 3714 such as a display, speakers, a printer, etc. may also be included. The aforementioned devices are examples and others may be used.

Computing device 3700 may also contain a communication connection 3716 that may allow device 3700 to communicate with other computing devices 3718, such as over a network in a distributed computing environment, for example, an intranet or the Internet. Communication connection 3716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 3704, including operating system 3705. While executing on processing unit 3702, programming modules 3706 (e.g., application 3720) may perform processes including, for example, stages of one or more of methods 200 and 300 as described above. The aforementioned process is an example, and processing unit 3702 may perform other processes. Other programming modules that may be used in accordance with embodiments of the present disclosure may include image encoding applications, machine learning application, image classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method of facilitating operations of vehicles, the method comprising:
receiving, using a communication device, a location of a mobile device associated with a vehicle;
retrieving parking data associated with the location from a storage device;
transmitting, using the communication device, the parking data to the mobile device, wherein the mobile device is configured to present the parking data to a user of the mobile device.

2. The method of claim 1, wherein the mobile device comprises at least one of a smartphone and a vehicle navigation unit.

3. The method of claim 1 further comprising receiving, using the communication device, at least one contextual variable, wherein retrieving the parking data is further based on the contextual variable.

4. The method of claim 1, wherein the contextual variable comprises at least one a time of day, a day of week, a lane of a road associated with the location, a level of traffic congestion in a vicinity of the location, a number of vehicles currently seeking parking in the vicinity of the location, at least one characteristic of a user associated with the vehicle, at least one characteristic of the vehicle, at least one permit associated with the vehicle and at least one parking violation associated with at least one of the vehicle and the user.

5. The method of claim 1 further comprising receiving, using the communication device, a filtering criteria, wherein presenting the parking data is based on the filtering criteria.

6. The method of claim 1 further comprising:
receiving, using the communication device, sensor data associated with at least one sensor comprised in the mobile device;
analyzing, using the processing device, the sensor data;
determining, using the processing device, a parking state associated with the vehicle based on the analyzing; and
storing the parking state in the storage device.

7. The method of claim 6 wherein, the parking data comprises at least one parking location and at least one availability associated with the at least one parking location, wherein the at least one availability is based on the parking state.

8. The method of claim 1 further comprising:
receiving, using the communication device, a parking update from the mobile device;
updating, using the processing device, the parking data based on the parking update; and storing the updated parking data in the storage device.

9. A method of facilitating parking of vehicles, the method comprising:
receiving, using a communication device, at least one parking update from at least one mobile device, wherein the parking update is associated with a location;
analyzing, using a processing device, the at least one parking update;
generating, using the processing device, parking data associated with the location based on the parking update; and
storing each of the parking data and the location in a storage device.

10. The method of claim 9, wherein the parking update comprises a plurality of scans comprising a plurality of portions of a parking sign, an image comprising the parking sign, a video comprising the parking sign and an audio describing the parking sign.

11. The method of claim 16, wherein the parking update comprises an image of the parking sign, wherein the analyzing comprises performing at least one of a supervised classification and unsupervised classification of the image based on machine learning.

12. The method of claim 10 further comprising:
receiving, using the communication device, the location from the mobile device; retrieving a plurality of predetermined parking data associated with the location from a storage device; and
transmitting, the plurality of predetermined parking data to the mobile device, wherein the plurality of predetermined parking data is presented on the mobile device, wherein the mobile device is configured to receive at least one selection of the plurality of predetermined parking data, wherein the at least one selection corresponds to the at least one parking update.

13. The method of claim 12 further comprising generating, using the processing device, the plurality of predetermined parking data based on predictive probabilities.

14. The method of claim 10, wherein the parking sign is subdivided into sections depicting key variables using machine vision and parsing code to identify key variables associated with parking sign(s).

15. The method of claim 10, wherein the parking sign is altered with new orientation, color manipulation, image filters, invert pattern recognition, inverse color, to accurately subdivide parking sign into key variables but not limited to before or after the method of claim 14.

16. The method of claim 10, wherein machine vision is used to perform image recognition or matching to predetermined image classification based on training data wherein gathered and/or sourced from a database of relevant parking data.

17. The method of claim 14, wherein optical character recognition uses all subdivided information to identify key words in part or in full.

18. The method of claim 10, wherein optical character recognition identifies key words in part or in full to categorize sign(s) into groups and subgroups and/or types and subtypes.

19. The method of claim 10, wherein scanned images are digitally created into a standard digital outlined version containing all relevant key variables.

20. The method of 19, wherein manual input of missing information can be added, wherein manual input of incorrect information can be changed and/or edited, wherein manual input of correct information can be confirmed.
